(19) United States
(12) Patent Application Publication
(10) Pub. No.: US 2005/0203775 A1
(43) Pub. Date: Sep. 15, 2005

(54) Automated reporting, notification and data-tracking system particularly suited to radiology and other medical/professional applications

(76) Inventor: Richard M. Chesbrough, Bloomfield Hills, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/079,263

(22) Filed: Mar. 14, 2005

Related U.S. Application Data
(60) Provisional application No. 60/552,554, filed on Mar. 12, 2004.

(51) Int. Cl. G06F 17/60

(52) U.S. Cl. 705/2

(57) ABSTRACT

An interactive web-based software solution and application service provider (ASP) program called RADAR™ enables instant notification and alert responses from busy physicians, healthcare providers, and other professionals. The RADAR system is a complete risk management program for healthcare and other communication solutions, providing alert and data management and tracking for important data for physicians and other professionals.

### REFERENCE TO RELATED APPLICATION

This application claims priority from U.S. Provisional Patent Application Ser. No. 60/552,554, filed Mar. 12, 2004, the entire content of which is incorporated herein by reference.

### FIELD OF THE INVENTION

This invention relates generally to the management of professional interactions and, more particularly, to an automated follow-up system and method for radiological and other medical/surgical alert procedures.

### BACKGROUND OF THE INVENTION

Various medical and professional practitioners must submit test reports to other individuals involved in heath care or other specialties. Since many of these intended recipients are extremely busy they are difficult to get a hold of. Since it is tedious and time-consuming to keep track of details such as who was called, when they were called and what outcome was achieved (i.e., a meaningful communication or a busy signal), there is always a risk that follow-up will “fall through the cracks.” Apart from the importance of patient care, the communication of important results can result in decreased liability for the healthcare provider and institution. As recognized by the Indiana Appellate Court (1999), “[t]he communication of important results is sometimes as important as the results themselves.”

While systems have been proposed to address some of these challenges, existing systems do not go far enough in terms of level of alert and other desirable functions. One approach is proposed in U.S. Pat. No. 5,754,111. According to this reference, medical alerting systems and procedures are provided to communicate a message representative of a healthcare condition to one or more target recipients. The system includes a receiver which accepts data or indicia of the healthcare condition, and a processor, which assigns a preselected output to the data or indicia and which maps the output to a particular primary target recipient. A transmitter then signals the preselected output to a target. The system can be set up to record a confirmation that the message has indeed been delivered to the target and can be programmed to escalate to a secondary target in the event the primary target does not acknowledge receipt within a preset time limit.

### SUMMARY OF THE INVENTION

This invention, called “RADAR™,” which stands for “Radiology Alert and Data Accrual Registry,” is an interactive web-based software solution and application service provider (ASP) program, designed to enable instant notification and alert responses from busy physicians, healthcare providers, and other professionals. The RADAR system is a complete risk management program for healthcare and other communication solutions, providing alert and data management and tracking for important data for physicians and other professionals.

Through the normal process of dictating an examination, reading a study, or performing a diagnostic test, the RADAR system can be implemented in a matter of seconds, notifying the ordering practitioner of important test results. In a preferred embodiment, the method of activation involves a click or clicks of a mouse, function key, or a simple voice recognition sequence to automatically enter a follow-up request. As an example, the simplified invocation might be interpreted to mean “RADAR ALERT 1” which, in turn, may be indicative of an urgent finding that would require notification to a referring physician within a particular time period. The request is preferably transmitted to a call-center (that can be located anywhere in the world) where a person follows up with the request. The result is a seamless, closed-loop and documented communication which is retrievable at a later date to prove that the communication took place and the content thereof. This efficiency makes the system usable to a wide variety of providers who do not have the time or inclination to use more cumbersome, commercially available systems.

RADAR also allows tracking of important test results, including data-tracking for JACHO inspections and MQSA mammography compliance programs. In the RADAR system, important data can be tabulated, stored and tracked for future reference. This comprehensive system allows for easy generation of data for institutional compliance and quality assurance. RADAR also allows for computerized notification of follow-up recommendations to both the patient and referring healthcare provider. All electronic communications are stored in the RADAR database for future reference.

In terms of a specific implementation, the system preferably using the following, through changes will no doubt be made as technology progresses:
PC-based format
Microsoft Windows-based operating system
HL-7 Interface
Compatible with current HIS/RIS systems (i.e. Cerner)
Compatible with voice recognition software (i.e. Powerscribe)

### BRIEF DESCRIPTION OF THE DRAWINGS

FIG. 1 shows a use case diagram according to the present invention;

FIG. 2A is a flow diagram indicating the way in which RADAR alerts are created;

FIG. 2B shows how the activity diagram is presented outlining the acknowledgement of RADAR alerts;

FIG. 3 is a diagram of an automated RADAR design implementation; and

FIG. 4 is a physical diagram illustrating the various web-based engines.

### DETAILED DESCRIPTION OF THE INVENTION

The RADAR system allows a comprehensive database to be established for the reporting and transmittal of important information such as test results. After a single, comprehensive data-entry procedure, users (“Senders”) are quickly identified through the use of current RIS password-protected log-in procedures. Preferably updated every 6 months, Senders are recognized by the system, allowing them to activate the RADAR program. This allows RADAR to always know who is placing test results or other information in the system, and to allow for consistent retrieval of verification information. Senders can “see” their statistics, database and any outstanding notifications using only their password, and a few clicks of the mouse. RADAR will automatically send statistics to all users for each block of time (preferably at 6-month, January-June and June-December intervals though this is variable). Other data may be easily requested by visiting the RADAR website, logging in and requesting additional personal database information.

Intended recipients (“Sendees”) are also recognized by RADAR, to complete each and every data transaction. After initial contact information has been input into the RADAR system, each Sendee is able to be located by RADAR, ideally within a matter of minutes, more or less, depending upon the level of urgency and/or other factors. This localization may involve a variety of communication modalities, including direct telephone calls for emergent findings, to Fax, letter and email notifications for non-emergent results. While Sendee contact information is input only once for each recipient, the program automatically sends a follow-up notice to each recipient contact, checking for notification changes and updating contact information. In cases where RADAR cannot locate the intended recipient, a notification is sent back to the Sender, alerting them to the fact that the intended person has not been able to be contacted. This alert prevents patients and results from “falling through the cracks,” which represents a high-liability situation when harm results.

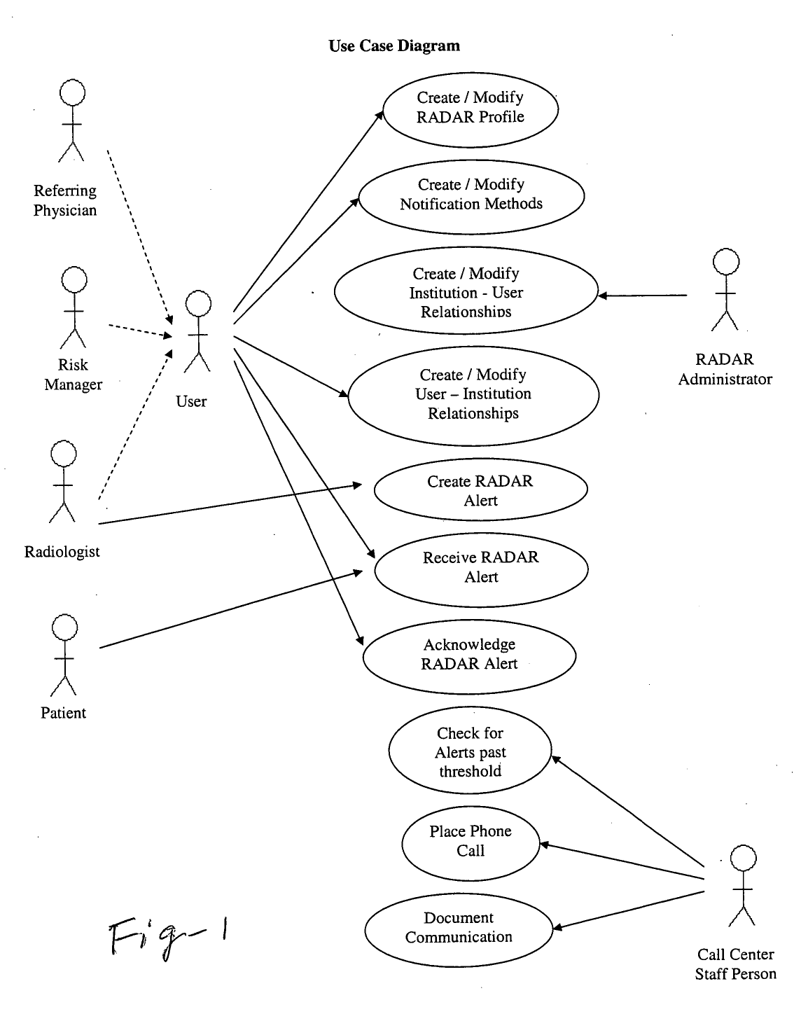

FIG. 1 is a use case diagram according to the invention. The referring physician is the licensed medical professional who orders the medical test on a patient for screening, diagnostic or therapeutic purposes. The Risk Manager is the individual in the medical organization who is responsible for documenting, reporting and responding to issues that arise that may lead to legal litigation. The Radiologist is the individual who interpreted the outcome of the medical test and dictates a report that is provided to the Referring Physician documenting his/her interpreted result.

The “user” is a generalization because, although different data may be gathered from each user the use cases within the system are the same. Users are actors who directly receive automated RADAR alerts based on their notification method of choice in their user profile. This excludes patients of course as Patients are not able to have user profiles and are only contact by a call center staff member as a last resort. The patient is the individual who had the medical test.

The RADAR administrator is an individual from the institution who must have access to HL7 values that identify particular users of the system as well as personal information such as date of birth and social security numbers so these values can be tied with existing RADAR user profiles. The Call Center Staff Person is an individual who will be responsible for following up on RADAR alerts that have gone unacknowledged for more than a period of time than is reasonable (deemed by Risk Manager). This actor must make contact with each party involved with the alert until the alert is acknowledged or the patient is directly informed that they need to seek a medical professional immediately.

### Use Cases

1.) Create/Modify RADAR Profile

The Create/Modify RADAR Profile would typically be the first use case of the RADAR system. This use case occurs when either a Referring Physician, Radiologist Risk Manager first logs in to the RADAR system. RADAR profiles exist independently of a particular institution so users can create their RADAR profiles whether or not their institution employs the RADAR system. Users will be asked to enter personal information such as name, home address, work address, so they can be easily contacted and information that only the RADAR administrator would be privy too such as date of birth and social security number. This personal information is crucial as it ensure that users can only receive RADAR alerts from the appropriate institutions. Institutions only link to a profile based on known personal information and users can only link to an institution if their personal information has been authorized by the particular institution.

The RADAR profile can be modified at any time by the user. Personal and contact information must remain accurate and both users and institutions are able to remove relationships between themselves at any time.

2.) Create/Modify Notification Methods

Users will have the ability to input various ways of communication for receiving RADAR alerts. These may include; email, fax, pager and a direct phone call made by Call Center Staff Person. Users will also have the ability to specify a notification method schedule in which they are able to instruct the system as to when and when not to send automated notifications. Notification Methods must be editable at anytime due to changing user needs but must allow for contact at least 4 hours per day and 3 days per week (this is to ensure that there is sufficient time for users to be made aware of alerts).

3.) Create/Modify Institution-User Relations

When the decision is made for an organization to use the RADAR system a RADAR Administrator is assigned. This is typically an individual from the institutions Information Technology/Systems department who is privy to data in HL7 messages that can be used to identify users. This actor gathers this information and enters it into the system along with personal identification information (SSN and DOB) and can be used to identify a user with the same information for notifications of alerts.

4.) Create/Modify User-Institution Relations

Throughout the life of the RADAR user profile users may be required to add or remove relationships to institutions to ensure they start/stop receiving automated alerts. This information may need to be edited at any time during the life of the RADAR user profile as users order exams, interpret and risk manage at different facilities. This use case would typically occur after specific user information has been authorized to receive alerts from a given institution. This would allow a user with a profile containing this information at build a relationship to this institution and start receiving RADAR alerts based upon the notification methods and preferences.

5.) Create RADAR Alert

Only Radiologists can create RADAR alerts. The physical act of creating RADAR alerts occurs during the dictation (or creation) of the report text. A predefined keyword (Such as “RADAR-Risk Management”) is included in the report text which would trigger to the computer system receiving the report that a RADAR event has occurred. Only one of each type of RADAR event can occur within an a report although an infinite amount of RADAR alert types can be included. The automated computer system would then created a record of this alert and begin to attempt to notify users tied to this RADAR alert based upon a finite set of rules derived from the alert type and the role each user was designated in the HL7 message.

| Keyword | Actions Taken |
|---|---|
| RADAR - Immediate Follow-up | Referring Physician has 24 hours to acknowledge |
| | alert. If not acknowledged the Radiologist is alerted |
| | for 24 hours. If not acknowledged the Risk |
| | Managers is alerted for 24 hours. If not |
| | acknowledged the Patient is notified directly to seek |
| | medical attention. |
| RADAR - 3 Month Follow-up | Referring Physician has 30 days to acknowledge |
| | alert. If not acknowledged the Radiologist is alerted |
| | for 7 days. If not acknowledged the Risk Managers |
| | is alerted for 7 days. If not acknowledged the Patient |
| | is notified directly to seek medical attention. |
| RADAR - 6 Month Follow-up | Referring Physician has 90 days to acknowledge |
| | alert. If not acknowledged the Radiologist is alerted |
| | for 7 days. If not acknowledged the Risk Managers |
| | is alerted for 7 days. If not acknowledged the Patient is |
| | notified directly to seek medical attention. |
| RADAR - Risk Management | The Risk Manager is alerted until acknowledged. |
| RADAR - Teaching File | No alerts are sent but a copy of this information is |
| | stored without patient demographics permanently for |
| | Radiologist's review. |
| RADAR - Peer Review | No alerts are sent but a link to this information is |
| | stored in the institutions peer review list that is |
| | worked by all radiologists belonging to institution. |

6.) Receive RADAR Alert

RADAR alerts can be received in many methods including email, fax, pager, automated phone call and call center phone call. Users are notified based on their notification preferences in their RADAR user profile. The information received on an alert is minimal and simply informs the users that there is a RADAR alert that needs acknowledgment, this can be done via the RADAR website.

7.) Acknowledge RADAR Alert

The acknowledgement of a RADAR alert is the single most important use case within the system and generally satisfies the main requirement of why the system was created. The main goal of the system is to inform the requesting physician of a significant finding and to accurately document this notification. If for some reason the referring physician is not able to be notified (by any means) the Radiologist and eventually the patient are notified that follow up is required. RADAR alerts must be acknowledged via the RADAR system website. Alerts sent do not include any patient demographics (to maintain HIPPA compliance) and simply instruct the user to acknowledge an outstanding RADAR alert.

In the rare event that the RADAR website is inaccessible in a user location RADAR alerts can be manually acknowledged via the call center with a call center staff person.

8.) Check for Alerts Past Threshold

The call center remains the ‘last resort’ for contact to acknowledge that a RADAR alert exists. Call Center Staff will constantly monitor the system for alerts that are not being responded to and will ensure that someone accepts responsibility and is notified of the situation.

9.) Place Phone Call

The call center staff is required to make phone calls to Radiologists, Referring Physicians, Risk Managers and even patients to do everything possible to ensure the patient is informed of the significant finding.

10.) Document Communication

It is imperative that all discussions with parties following up on RADAR alerts are well documented as these documents could be used in court against a user who may not have appropriately responded to an alert.

For manual acknowledgement over the phone with a staff person of RADAR alert phone calls may be recorded for medical legal purposes.

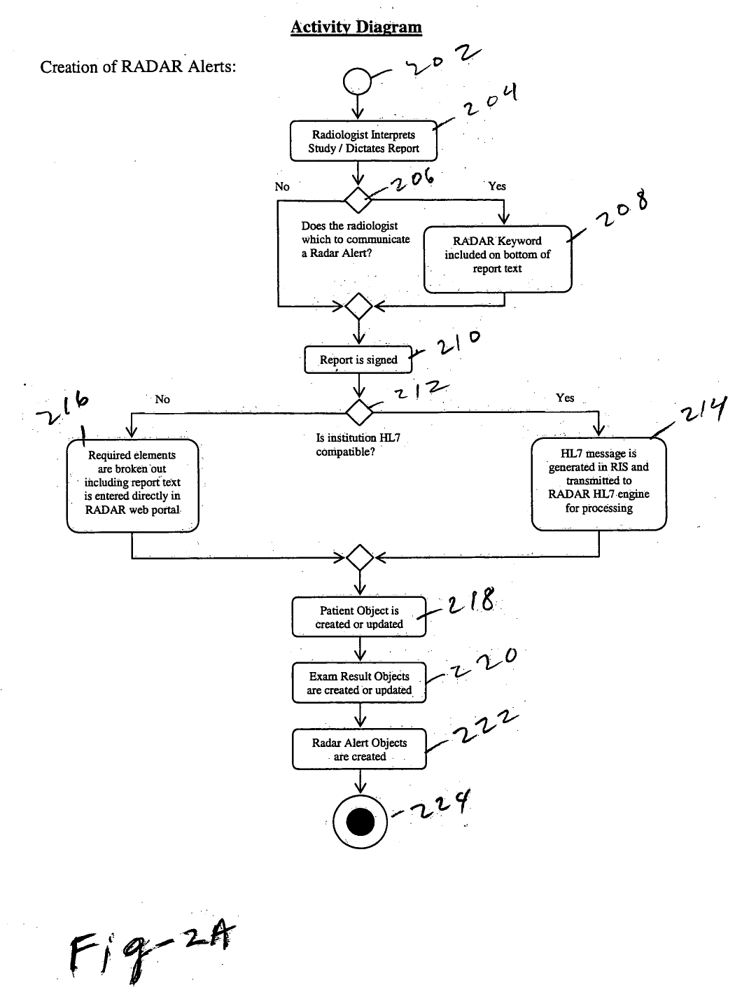

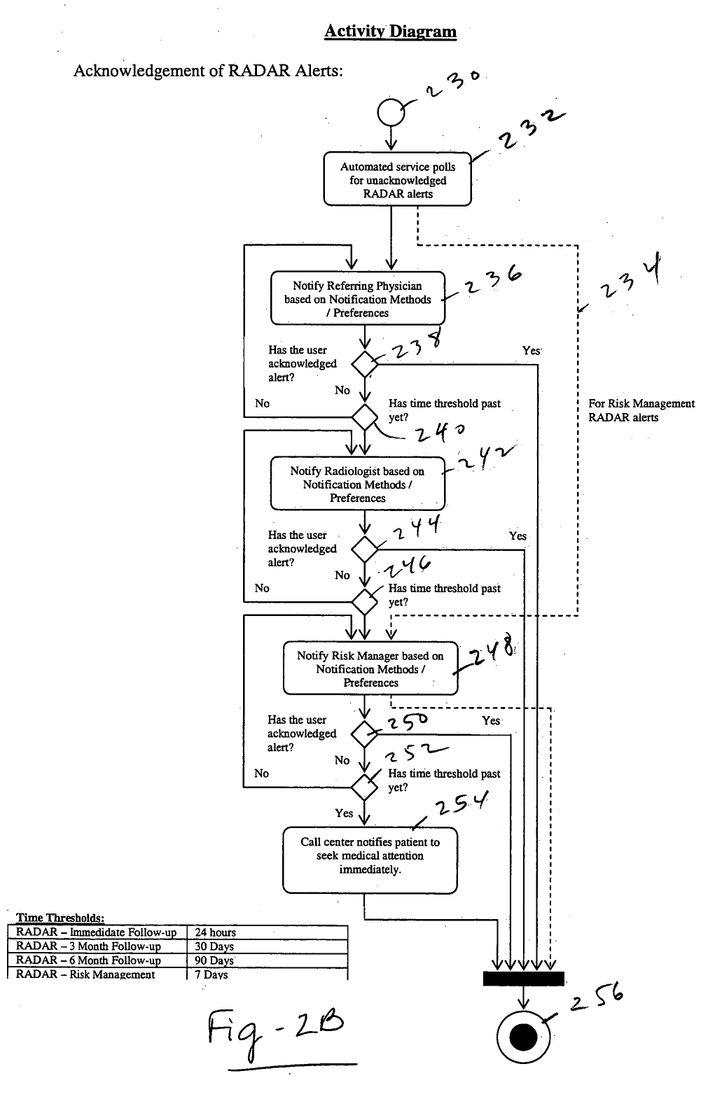

FIG. 2A is a flow diagram indicating the way in which RADAR alerts are created. Beginning at 202, the radiologist interprets a study and dictates a report at 204. At 206 the query is made regarding whether or not the radiologist wishes to communicate a RADAR alert. If so, the RADAR key word is included on the bottom of the report text at 208, and signed at 210.

At 212, HL7 compatibility is determined, and if this is the case, an HL7-compliant message is generated when transmitted for processing at 214. If not, required elements are broken out including report text which is entered directly into the RADAR web portal (216). The patient object data type is created or updated at 218, and exam result objects are created or updated at 220. At 222, RADAR alert objects are created, completing the process at 224.

Continuing on to FIG. 2B, an activity diagram is presented which outlines the acknowledgement of RADAR alerts. Beginning at 230, an automated service pulls for unacknowledged RADAR alerts at 232. Risk-management RADAR alerts follow broken-line path 234, to block 248, which will be discussed hereinbelow.

Referring positions are notified based on notification methods or preferences at step 236, and at decision point 238, the question is asked whether the user has acknowledged the alert? If so, the acknowledgement process is concluded, following a path to the end point 256. If not, however, the question regarding time threshold is asked at 240, and if this has passed, flow proceeds to block 242. If the time threshold has not yet passed, the system moves back to block 236.

At block 242, the radiologist is again notified in accordance with preferred methods/preferences, with the question again being asked at 244 regarding whether the user has acknowledged the alert. If so, the process terminates, but if not, a loop is made back to step 242.

At block 248, if the time threshold has passed for risk management RADAR alerts, or if flow has proceeded to this point from the above description, the risk manager is notified based upon notification methods/preferences, and if the user has acknowledged the alert at 250, the process terminates. If not, however, at 252 the question is asked whether the time threshold has passed, and if not, control loops back to block 248. If, however, the time threshold has passed, a call center notifies the patient to seek medical attention immediately at step 254.

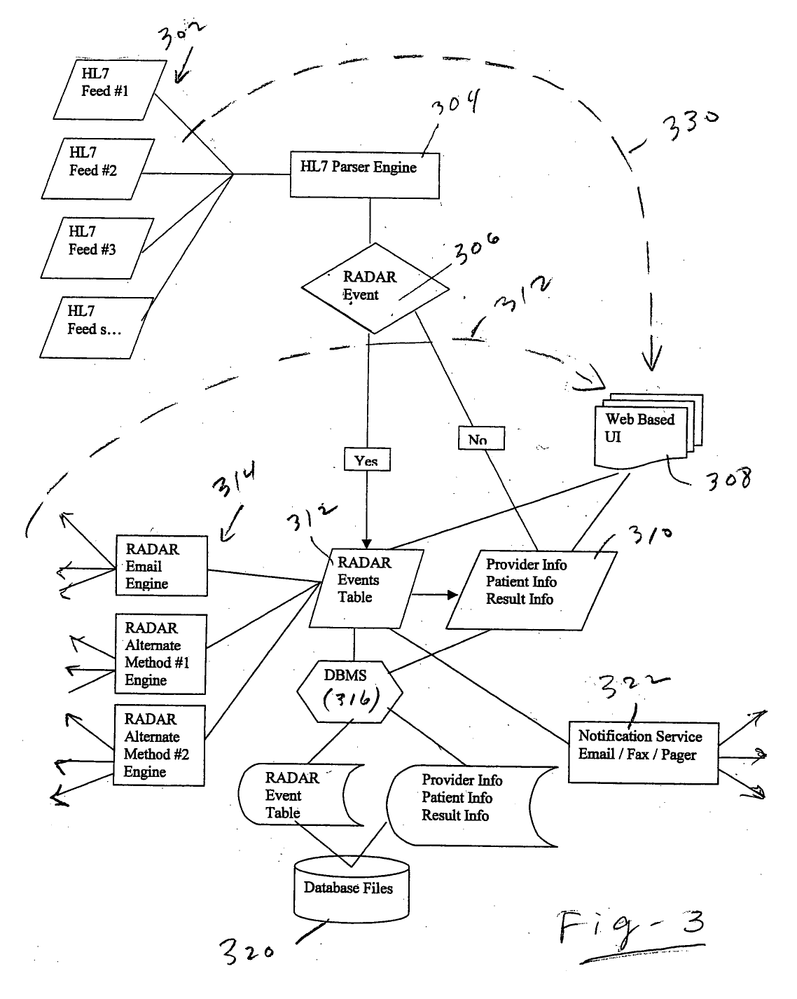

FIG. 3 is a diagram of an automated RADAR design implementation. The ‘feeds’ 302 introduce tags or “triggers” in to a report which indicate alert level in addition to other pertinent information. The triggers in the report are recognized by the HL7 parser engine 304, thereby automatically activating a series of events at 306 to alert the intended parties. The “alert” refers the recipient (referring healthcare provider) to their personal RADAR web-base user interface (UI) 308 where all alerts are posted (with patient name, record #, hospital or clinic location, and actual report at 310) that triggered that alert. Thus, according to the invention, a physician or other healthcare provider may receive a phone call, page, fax, email, or text message directing that person to their personal RADAR webpage, where the alert on their patient will be posted. They can then click on the page to read the report and alert notice. In this way, the systems avoid sending any patient information out over phone lines or into cyberspace, but simply have the doctor notified to go to their webpage.

In addition, the webpage is where the personalized data and tracking information is stored, for both radiologist user and referring provider. This allows the radiologist (and his/her group) to mine the data for additional information, and allows measurement of individual radiologists' productivity. Cases referred for follow-up are placed here for longitudinal tracking purposes. Note that documents or other information may be entered directly through the UI via path 312.

If a RADAR event is created at 306, flow proceeds to RADAR events table 312, which refers to database 310 to drive certain engines 314 to ensure that the appropriate persons are alerted. The database management system 316 coordinates actions between the events table and database 310, and database files 320. Notification services 322 include e-mail, fax, pager, or any other means necessary to provide closed-loop communication. As with the other embodiments described herein, if no contact is made, defaults are activated to others, or to the initial reporter, perhaps through a call center, to make certain that follow-up is provided for.

No case is allowed to “fall through the cracks.” If a RADAR alert is unacknowledged for a defined period of time, the alert goes to the next person in the algorithm—as specified by the referring provider during their initial registration process. This continues until the Call Center is contacted, the department Chairman is notified, the case is referred back to the radiologist who activated the alert, or (optional) the patient is notified of the alert and the need for clinical follow-up (or all the above events simultaneously).

A primary objective is to “parse” or filter a data stream (HL7 or whatever computer language) and extract important bits of data from the stream. This can occur with every radiology case read by the radiologist (full stream), or may occur only when a specific RADAR tag is placed (specific stream of data). These bits of data act to automatically trigger a cascade of automated events: such as alerts, follow-ups, data to be tabulated within the database, data for data mining, and so on.

The Call Center acts as a default to the automated process. If necessary, an alert will be sent to a Call Center to act on that alert and contact alternate people—by another person. In the preferred embodiment, this would not be a “first line” activity, but would be a back-up situation for select cases where the automated alert has not been received and acknowledged within certain defined parameters.

In place of, or in addition to the use of a website, the invention anticipates provisions whereby appropriate users can access a toll-free number, and have alert information manually or automatically. Note further that report initiators may put images or reports directly into the website via pass 330 utilizing the web-based UI. To ensure that the system is at all times operating properly, a “heartbeat” mechanism may be incorporated, whereby information is sent to physicians, medical practitioners, or other authorized personnel, for the sole purpose of forcing them to make an input into the system to verify that they are still reachable. Such a heartbeat signal may, for example, ask them to call a particular phone number, input web-based data, or make any changes that may be on record with regard to their contact information.

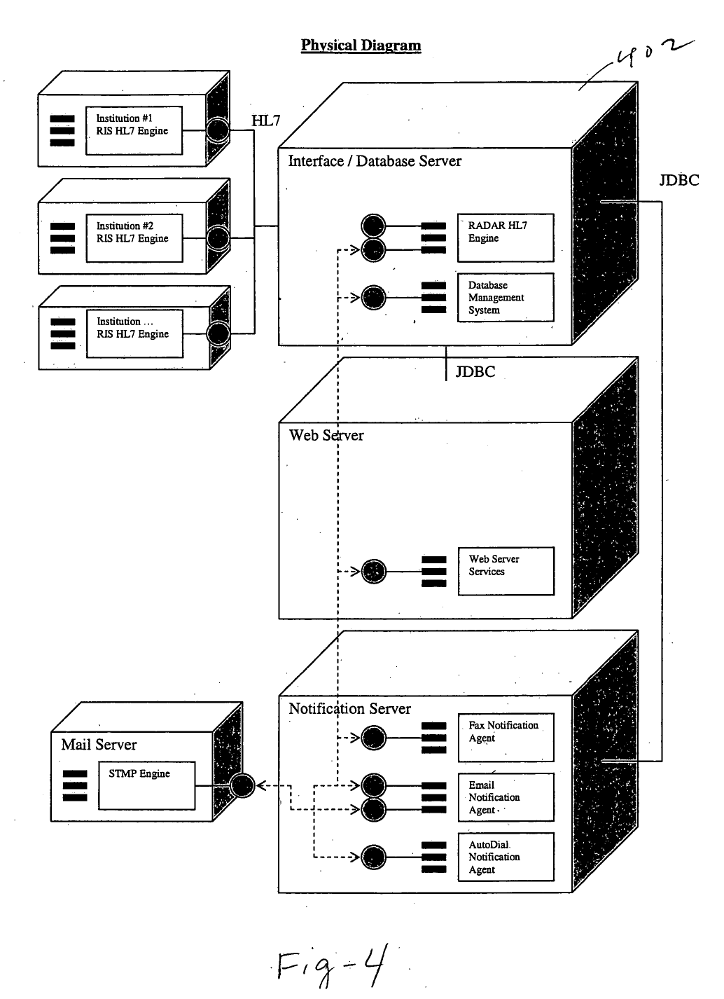

FIG. 4 is a physical diagram illustrating the various web-based engines operative to carry out alert directives. An interface/database server 402 includes a RADAR/HL7 engine, and a database management system. The web server itself provides the usual web server interfaces and protocols, and notification server includes mechanisms for fax/e-mail and auto-dial notification, as indicated by block 322 in FIG. 3. The institutions inputting the information, preferably through HL7 feeds, are shown in the upper lefthand portion of the diagram, and the mail, based upon an STMP engine, is shown at the lower left.

Radiology Administrator/Scheduling

Certain reports will generate the need for follow-up studies. RADAR will automatically transmit follow-up information to the appropriate department (radiology, for example), to arrange for additional studies (without the radiologist or other specialist having to be involved).

Preferred information included for Senders and Sendees includes the following:
Name
Home Address
Home Phone Number
Office Address
Office Phone Number
Office Fax Number
Cell Phone Number
Email Address
Pager Number
On-Call Number
Physician Back-up Number(s)*Alternate Numbers (back-up call personnel)
Mother's Maiden Name (used only for Password verification problems)
   Emergent/Urgent Findings: (Priority One: within 1 Hour)
1. Users:
   Radiology
   Laboratory Services
   Cardiology (EKG's)
   Physician Offices/Consulting Services

RADAR allows for near-instantaneous notification and verification of critical X-ray findings, EKG's, abnormal laboratory results, consults and other important medical test results—using direct human notification and electronic capture of patient database information. The ordering physician/provider, or intended recipient, receives a direct phone call from RADAR personnel (through the call center), informing them of an emergent/urgent result on their specified patient, and what type of test was performed. While not privileged to patient-specific details or HIPPA-protected information, the ordering doctor (or appropriate staff personnel) is told of the emergent findings on the patient. They are given contact number(s) of the sending provider/department and/or are referred to the voice-recorded result (i.e. RTAS-type system), or typed stat report in the RIS/HIS system. The time, date and names of persons contacted are recorded at the time of RADAR notification database.

A permanent record of notification and receipt is retained in the program file for each patient, indexed by their patient ID number, or name (Last Name, First Name). The RADAR notification logo is imprinted on the final patient report, as a permanent reminder that the RADAR alert system was activated. A receipt of the transaction is faxed and/or emailed to each physician involved with the case (generally the ordering doctor and dictating physician or technologist). A copy is also forwarded to the patient chart. Options include additional hard-copy letters to patients and/or referring physicians.

Significant, Unexpected Findings: (Priority Two: within 24 Hours)

RADAR allows for rapid notification and verification of unexpected, non-emergent X-ray findings, EKG's, abnormal laboratory results and other medical test results—using direct human notification through the call center and electronic capture of patient database information. A permanent record of notification and receipt is retained in the program file for each patient. The RADAR notification logo is imprinted on the final patient report, as a permanent reminder that the alert system was activated. A receipt of the transaction is faxed and/or Emailed to each physician involved with the case (generally the ordering doctor and dictating physician or technologist). A copy is also forwarded to the patient chart. Options include hard-copy letters to patients and/or referring physicians.

Follow-Up Recommendations: (Priority Three: within 48 hours)

The program also takes care of follow-up recommendations, by sending the referring physician an email and/or fax reminder on each patient. All cases are sent into a “tickler” tracking program to notify the interpreting service (i.e. radiology) of the need for a follow-up study. These reports will be sent to the radiology scheduler/administrator, to arrange for follow-up imaging.
1. Obtain Old Studies/Outside Studies:
   a. Report, Fax & Email to Referring Physician
   b. Placed in 1 month tracking program
2. Obtain Additional Studies:
   a. Report to Patient
   b. Report, Fax & Email to Referring Physician
   c. Placed in 1 month tracking program
3. Follow-up 1-2 Weeks:
   a. Report to Patient
   b. Report, Fax & Email to Referring Physician
   c. Placed in 1 month tracking program
4. Follow-up 1 Month:
   a. Report to Patient
   b. Report, Fax & Email to Referring Physician
   c. Placed in 1 month tracking program
5. Follow-up 3 Months:
   a. Report to Patient
   b. Report, Fax & Email to Referring Physician
   c. Placed in 3 month tracking program
6. Follow-up 6 Months:
   a. Report to Patient
   b. Report, Fax & Email to Referring Physician
   c. Placed in 6 month tracking program
7. Follow-up 12 Months:
a. Report to Patient
b. Report, Fax & Email to Referring Physician
c. Placed in 12 month tracking program
   Teaching File/Resident Functions

1. Data Collection:

RADAR allows for easy tracking and data collection of interesting cases for a personal teaching file, or for resident teaching material. By activating the “Teaching File” function on RADAR, a case is automatically saved in the file, according to modality. CT's are saved in the CT section, while General Cases and MRIs are saved in their respective sections.

2. Data Tracking:

Resident and Fellow Cases may also be tracked in the RADAR program. When the staff is reviewing resident work, he/she may correct a report and send notification of the correction back to the resident. This is important as a teaching tool, as well as internal QA function. A significant change is handled the same as a Peer-Review “Disagree,” where a notification is sent immediately to the referring provider (see below under Peer Review Program).

### Example: BIRADS

While not designed as a research tool for academic breast centers, the RADAR system allows for basic data generation, required by the government through the MQSA standards. No separate mammography tracking program is required, (short of in-depth research programs that may require more detailed analysis). The RADAR program will easily collect required breast data, and guide the busy clinical radiologist through the MQSA process. This allows the center to continue their qualification for ACR accreditation, which is needed for Medicare and insurance reimbursement. The busy radiologist can easily indicate the appropriate BIRADS number at the end of the dictation, indicating the need for one of the following:
1. BIRADS 1:
   a. Negative/Complete (no additional testing)
   b. Report to Patient with 1-year reminder
   c. Report & Email to Referring Physician
   d. (*Optional): Tracking reminder in one year to Physician and/or Patient
      Email
      Fax
      Regular Mail
2. BIRADS 2:
   a. Benign Findings/Complete (no additional testing)
   b. Report to Patient with 1-year reminder enclosed
   c. Report & Email to Referring Physician
   d. (*Optional): Tracking reminder in one year to Physician and/or Patient
      Email
      Fax
      Regular Mail
3. Call Back/Additional Diagnostic Workup (mammograms and/or ultrasound)
   a. Report to Patient
   b. Report, Fax & Email to Referring Physician
   c. Placed in one-month tracking program
   d. Calculate call-back rate (call-backs/total # screens)
4. Probably Benign/6-month follow-up
   a. Report to Patient
   b. Report, Fax & Email to Referring Physician
   c. Placed in 6-month tracking program
5. Suspicious Findings:
   a. Report to Patient
   b. Report, Email & Fax to Referring Physician
   c. Placed in tracking program
   d. Rad-Path Concordance Reminder
      Completed by radiologist
      Calculates PPV
      Calculates size of lesion (i.e., desire 50% or more—less than 2 cm size, type of lesion)
         Additional MQSA-required data is easily managed by the RADAR system. By appropriate indication at the end of the dictation, the following data can be quickly acquired:
Number of mammograms interpreted
Call-Back rate (expressed as a percentage of cases read)
PPV—when biopsy is recommended.
Size of Cancers Detected
   Radiologist Data Tracking: (For Radiologists and Radiology Residents)
1. Number of Cases read
   a. Specific Types of Modalities
      (i.e. Head CT's, Brain MRIs, Abd CT's, etc. . . . )
   b. ACR coding of case diagnoses
      (i.e. Glioblastoma, Renal Cell CA, etc. . . . )
   c. Interesting Case data base
2. Mix of cases (RVU's):
   a. General Radiology
      i. Plain Radiographs
      ii. Fluoroscopy Cases (BE, UGI, UVP)
   b. Mammograms
   c. Ultrasound Cases
   d. CT Scans
   e. MRI Examinations
   f. Nuclear Medicine Cases
   g. Special Procedures (Interventional, CT, US-guided procedures)
3. Peer-Review Program Tracking (see below)
   Tracks the overall number of cases peer-reviewed per 6-month period of time
   Tracks the number of “Agrees”
   Tracks the number of “Disagrees”
   Allows for identification of problem readers.
   Provides ammunition for institution that providers are actively engaged in meaningful peer review process.
      Physician Peer-Review Program:

The Joint Commission of Health Care Organizations (JACHO) and other governing bodies are currently asking for more oversight of physician and provider practice patterns. One statistic that is being sought is the number of cases where a second review has been performed. This includes cases where there is agreement between two readers, as well as cases where there is a difference of opinion. Currently, few physicians are performing “meaningful” peer review, primarily because it is time intensive and difficult to generate significant numbers of cases.

RADAR solves this problem through novel peer-review tracking system. As a case is being read, often times the prior case and report are reviewed to evaluate for any changes. This is common practice in mammography, as well as in the reading of chest X-rays, CT's, Ultrasounds and other imaging studies. Such a review of old studies provides the perfect opportunity for easy peer-review of prior interpretations. The current, dictating radiologist must only indicate that he/she agrees with the prior report (“Peer Review-Agree”), or that there is a significant discrepancy in the interpretation (“Peer Review-Disagree”).

Agree:

In cases of an “Agree,” RADAR automatically places the results into the provider data-base, tracking the patient ID number, date of reading, and tabulating the number of cases peer-reviewed. This information is then available for JACHO review, or for review by other interested organizations. It is also critical information in cases of legal action, where proving peer-review of a case may be helpful to the defense of a malpractice claim.

Disagree:

In case of a “Disagree,” the RADAR system automatically contacts the referring doctor/provider, notifying them of a change in the report (similar to notification under “Emergent/Urgent Notification”). At the time of reading, the radiologist must also fill out a short electronic format, indicating what the difference of opinion is, and any changes in the patient management. This information is also available for JACHO review, or for review by other qualified organizations. It is also critical information in cases of legal action, where proving notification of change-of-report may be crucial to the defense of a malpractice claim.

As an (optional) additional RADAR feature, a notification of “Disagree” on a specific patient case is automatically sent to the original interpreting physician, for internal QA, and as a learning tool for the interpreting radiologist.

Resident and Fellow Cases

Resident and Fellows in training may also have their work tracked with the RADAR program. When the staff physician is reviewing resident/fellow preliminary interpretations, the staff may find that there is significant disagreement in the final report. The staff may then correct a report and send notification of the correction back to the resident. This is important as a teaching tool, as well as internal QA function. A significant change is handled the same as a Peer-Review “Disagree,” where a notification is sent immediately to the referring provider (see Peer Review Program).

All of this data is tracked by the RADAR program, for semi-annual review by the physicians, administrators, or governing bodies. Peer-Review Program Functions:
Tracks the overall number of cases peer-reviewed per 6-month period of time
Tracks the number of “Agrees”
Tracks the number of “Disagrees”
Allows for identification of problem readers.
Provides ammunition for institution that providers are actively engaged in meaningful peer review process.
   Second Opinion Option

Similar to the Peer-Review portion of RADAR for radiology, the “Second Opinion” option allows for easy facilitation and tracking of an over-reading on a particular case. If the first reader wants a specific physician/colleague to review a case, he/she can activate the “second reader” function of the program. This will send a message to that second radiologist, indicating a request for an opinion on a study. The radiologist can then call-up the study and dictate an opinion/amendment to the first report. A copy of this will be sent back to the first reader, within 48 hours of the second reading.

1. A closed-loop method of communicating information about a condition, comprising the steps of:
a) inputting contact information pertaining to one or more persons to be notified about a condition, and information regarding modes of communication to reach the persons;
b) receiving a report from a source which may include an alert regarding the condition;
c) attempting to communicate the alert to one of the persons to be notified using one of the modes of communication; and
d) repeating step c) as necessary until the alert has been communicated or information about the alert has been stored.

2. The method of step 1, wherein the information about the alert includes information concerning the attempt(s) to reach the person(s) to be notified.

3. The method of claim 1, wherein the modes of communication are based upon level of urgency.

4. The method of claim 3, wherein the mode of communication involves a telephone call.

5. The method of claim 3, wherein the mode of communication involves an automated telephone call.

6. The method of claim 3, wherein the mode of communication involves electronic mail.

7. The method of claim 3, wherein the mode of communication involves a facsimile or letter.

8. The method of claim 1, including the step of notifying source of the report if the person(s) to be notified could not be reached.

9. The method of claim 1, wherein the condition involves a medical test result.

10. The method of claim 1, wherein:
the condition involves a medical test result; and
the mode of communication involves a telephone calls for an emergent finding, or a fax, letter or e-mail notification for a non-emergent finding.

11. The method of claim 1, further including the step of providing a web-based user interface to perform steps a), b) or c).

12. A closed-loop method of communicating information about a medical condition, comprising the steps of:
a) inputting contact information pertaining to one or more persons to be notified about the medical condition, and information regarding modes of communication to reach the persons;
b) receiving a diagnostic report from a source which may include an alert regarding the condition;
c) attempting to communicate the alert to one of the persons to be notified using one of the modes of communication; and
d) repeating step c) as necessary until the alert has been communicated or information about the alert has been stored.

13. The method of step 12, wherein the information about the alert includes information concerning the attempt(s) to reach the person(s) to be notified.

14. The method of claim 12, wherein the modes of communication are based upon level of urgency.

15. The method of claim 12, wherein the mode of communication involves a telephone call.

16. The method of claim 12, wherein the mode of communication involves an automated telephone call.

17. The method of claim 12, wherein the mode of communication involves electronic mail.

18. The method of claim 12, wherein the mode of communication involves a facsimile or letter.

19. The method of claim 12, including the step of notifying source of the report if the person(s) to be notified could not be reached.

20. The method of claim 12, wherein the medical condition involves a radiological test result.

21. The method of claim 12, wherein the medical condition involves a laboratory test result.

22. The method of claim 12, wherein mode of communication involves a telephone calls for an emergent finding, or a fax, letter or e-mail notification for a non-emergent finding.

23. The method of claim 12, wherein the alerts are HL7 compliant.

24. The method of claim 12, further including the step of providing a web-based user interface to perform steps a), b) or c).

25. The method of claim 12, further including the steps of:
contacting the person to be notified; and
directing that person to a web site to obtain further information regarding the diagnostic report or alert condition.

26. The method of claim 12, further including the steps of:
performing an independent review of the report; and
entering into the database an AGREE or a DISAGREE by the peer with respect to an opinion in the report.

27. The method of claim 12, further including the steps of:
performing an independent review of the report;
entering into the database an AGREE or a DISAGREE by the peer with respect to an opinion in the report; and
requesting a second opinion with respect to the report.
